(19) United States
(12) Patent Application Publication
(10) Pub. No.: US 2019/0362241 A1
(43) Pub. Date: Nov. 28, 2019

(54) SYSTEMS AND METHODS FOR CONFIGURING AN ONLINE DECISION ENGINE

(71) Applicant: PAYPAL, INC., San Jose, CA (US)

(72) Inventor: Shihao Ren, Nantong (CN)

(21) Appl. No.: 15/986,523

(22) Filed: May 22, 2018

(51) Int. Cl. G06N 5/02; G06F 17/50; G06F 8/30; G06F 17/30

(52) U.S. Cl. CPC G06N 5/02; G06F 17/30864; G06F 8/31; G06F 17/5009

(57) ABSTRACT

Methods and systems are presented for configuring an online decision making engine based on performing simulations of one or more decision making algorithms using online data. A decision making system may obtain first programming codes that implement a decision making algorithm in a first programming language corresponding to the online decision making engine. Without any human interference, the decision making system may automatically generate second programming codes that implement the decision making algorithm in a second programming language corresponding to database system. The decision making system may then simulate the decision making algorithm using the second programming codes to generate simulation results. Based on the simulation results, the decision making system may configure (or re-configure) the online decision making engine.

### BACKGROUND

The present specification generally relates to decision making engines, and more specifically, to providing an online simulation mechanism to configure the decision making engines, and allowing for faster and simplified data access that enables more rapid decision making.

### RELATED ART

Decision making engines may be found in many computer systems. For example, in access control systems for various electronic user services, decision making engines may be implemented to determine whether to authorize a user to access an account and/or whether to authorize processing of an electronic request. These systems not only have to enable authorized users to access their accounts and perform authorized transactions, they also have to prevent unauthorized users from accessing data and performing unauthorized transactions (e.g., a transaction being attempted by someone other than a legitimate user for a specific user account).

As the trends of hacking change over time and apply increased pressure against system administrators to prevent unauthorized transactions, decision making engines need to be adjusted (e.g., re-configured) from time to time to maintain (or improve) the effectiveness of identifying fraudulent access and/or user actions. A simulation engine may be used to simulate the effect of various decision making rules and/or computer models to determine which of the decision making rules and/or models should be used in the decision making engine. Since a decision making engine and a simulation engine may be based on non-compatible platforms, in some instances, the decision making rules that are ultimately deployed in a decision making engine that supports a first programming language may have to be written (e.g., by a software developer) in a second programming language first in order for the simulation engine to perform the simulations. After the simulations, the decision making rules may then be written in the first programming language for implementation in the decision making engine. That is, one language may be used to test a new or modified decision making rule (e.g., to ensure that the rule does not interfere with system performance or otherwise appears to be operating as expected) while a different programming language may have to be used to actually implement the rule within a decision engine, which may have to make extremely rapid decisions (e.g. within milliseconds) in an online environment. Further, since the simulation engine has to wait for data collected by the decision making engine to be imported (which may take days) into a database corresponding to the simulation engine, the data used by the simulation engine may not reflect the current trend in fraudulent access attempts. Thus, there is a need for a system that provides easier transition between the simulation engine and the online decision making engine to improve the quality of the online decision making engine.

### BRIEF DESCRIPTION OF THE FIGURES

FIG. 1 is a block diagram illustrating an electronic transaction system according to an embodiment of the present disclosure;

FIG. 2 is a block diagram illustrating a decision making module according to an embodiment of the present disclosure;

FIG. 3 is a flowchart showing a process of evaluating a decision making algorithm for an online decision engine according to an embodiment of the present disclosure;

FIG. 4 illustrates an exemplary decision tree according to an embodiment of the present disclosure;

FIG. 5 is a block diagram illustrating an online decision engine according to an embodiment of the present disclosure;

FIG. 6 is a block diagram illustrating an engine optimization module according to another embodiment of the present disclosure; and

FIG. 7 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for configuring an online decision making engine based on performing simulations of one or more decision making algorithms using online data. A decision making system may obtain first programming codes that implement a decision making algorithm in a first programming language corresponding to the online decision making engine. The first programming codes may be an imperative programming language that can be compiled and executed on a computer device. Without any human interference, the decision making system may autonomously generate second programming codes that implement the decision making algorithm in a second programming language corresponding to a database system. In some embodiments, the second programming language is a query language that provides an interface for direct access to a database system, such that the second programming codes, when executed by a computing device, may directly access the data sets stored on the database system. The decision making system may then simulate the decision making algorithm using the second programming codes (e.g., by executing the second programming codes on the data sets stored on the database system) to generate simulation results. Based on the simulation results, the decision making system may configure (or re-configure) the online decision making engine.

To generate the second programming codes, the decision making system may first parse the first programming codes and transform the first programming codes into an abstract syntax tree. The abstract syntax tree represents the logic of the decision making algorithm implemented by the first programming codes, in various embodiments. The decision making system may then generate the second programming codes based on the abstract syntax tree.

In some embodiments, the decision making system may also obtain online activity data that is logged by the online decision making engine. The online activity data may include data related to requests (e.g., electronic access requests, electronic transaction requests, etc.) that have passed through the online decision making engine. For example, when a request (e.g., a login request, an electronic transaction request, etc.) is received by a web server, the web server may use the online decision making engine to determine whether to authorize such a request. The online decision making engine may retrieve information relevant to the request (also referred to as activity data herein) and may log the data for each request it receives. The information may include at least a user account that is associated with the request, the Internet Protocol (IP) address of a source of the request, a number of successful transactions associated the user account within a predetermined period of time, a number of failed transactions associated with the user account within the predetermined period of time, a time, a browser type, a device type, an amount associated with the transaction, a transaction type of the transaction, or other information that may be used by the online decision engine to determine whether to authorize the request.

In some embodiments, the logged activity data may be unstructured. For example, the logged activity data may include a stream of text. As such, in some embodiments, the decision making system may generate structured activity data based on the logged activity data. In order to generate the structured activity data, the decision making system may generate a data structure for storing the activity data. The data structure may include variable types related to the requests and are relevant for the decision making engine to generate a decision.

Once the data structure is generated, the decision making system may use a set of logging rules associated with logging the online activity data to extract variables corresponding to the variable types from the logged activity data. The decision making system may continuously extract the variables and insert the variables into the data structure as new activity data is logged by the online decision making engine. Since the decision making system may include new activity data in the data structure substantially simultaneously (e.g., within a predetermined time frame such as within seconds or within milliseconds, etc.) as the new online activity data is logged by the online decision making engine, the structured activity data may include the most recent online activity data. As such, the structured activity data is referred to as online activity data. The structured activity data may then be used by the simulation engine to perform the simulations, for example by executing the second programming codes on the structured activity data stored in the data structure.

Since the second programming codes are derived from the first programming codes written for the online decision engine, the variable names in the data structure may not completely match the variable names used in the second programming codes. As such, the decision making system may map the variable names in the first programming codes to the corresponding variable names in the data structure during or after the logging process. The decision making system may then use mapped variables in the second programming codes such that the second programming codes may be properly executed on the data structure.

Upon obtaining the simulation results from performing the simulation, the decision making system may modify the online decision making engine based on the simulation results. For example, when the decision making algorithm has not yet been incorporated into the online decision making engine, the decision making system may incorporate the decision making algorithm into the online decision making engine based on the simulation results.

In some embodiments, the online decision making engine may include active decision making algorithms and inactive decision making algorithms. Active decision making algorithms are algorithms currently utilized by the online decision making engine in evaluating incoming requests. On the other hand, inactive decision making algorithms are not being utilized by the online decision making engine in evaluating incoming requests. The inactive decision making algorithms may have been active in the past, but were turned into an inactive state based on factors such as a change of a trend (e.g., the type of fraudulent schemes that the decision making algorithm was used to detect is no longer popular), replaced by a newer version of the decision making algorithm, etc. In one example, the decision making algorithm is an inactive decision making algorithm in the online decision making engine. In this example, the decision making system may determine, based on the simulation results, that the type of fraudulent schemes that the decision making algorithm was used to detect is trending again. As a result, the decision making system may activate the decision making algorithm (e.g., turn the decision making algorithm from an inactive state to an active state) based on the simulation results.

In another example, the decision making algorithm may be associated with a threshold value. For example, the decision making algorithm may compute a confidence score based on information related to a request, and may produce an outcome (e.g., authorize or deny a request) based on the confidence score relative to the threshold value. In some embodiments, the decision making system may modify the threshold value of the decision making algorithm based on the simulation results. For example, the decision making system may perform simulations of the decision making algorithm using different threshold value candidates, and may select a threshold value candidate that optimizes the detection of fraudulent transactions based on the simulation results.

In yet another example, a newer version of the decision making algorithm may be obtained. In this example, the decision making system may perform simulations for both versions of the decision making algorithm and may select a version based on the simulation results.

Thus, by using such a decision making system according to various embodiments of the disclosure, the online decision engine may be more optimally configured, based on simulations that may be performed frequently and using online activity data.

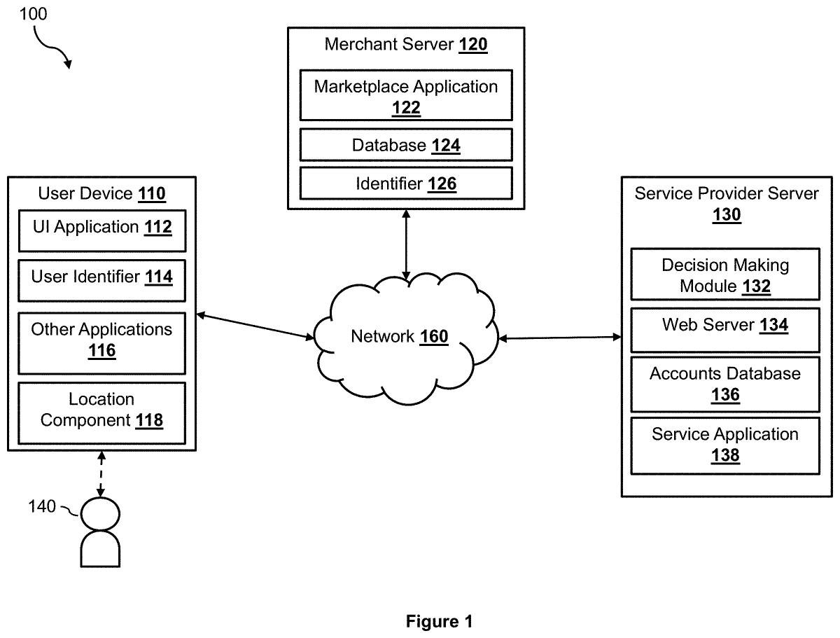

FIG. 1 illustrates an electronic transaction system 100 within which a decision making system may be implemented according to one embodiment of the disclosure. The electronic transaction system 100 includes a service provider server 130, a merchant server 120, and a user device 110 that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the merchant server 120 and/or the service provider server 130 over the network 160. For example, the user 140 may use the user device 110 to log in to a user account to conduct account services or conduct various electronic transactions (e.g., electronic payment transactions, etc.) with the service provider server 130. Similarly, a merchant associated with the merchant server 120 may use the merchant server 120 to log in to a merchant account to conduct account services or conduct various electronic transactions (e.g., electronic funds transactions, etc.) with the service provider server 130. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface (UI) application 112 (e.g., a web browser), which may be utilized by the user 140 to conduct electronic transactions (e.g., shopping, purchasing, bidding, etc.) with the service provider server 130 over the network 160. In one aspect, purchase expenses may be directly and/or automatically debited from an account related to the user 140 via the user interface application 112.

In one implementation, the user interface application 112 includes a software program, such as a graphical user interface (GUI), executable by a processor that is configured to interface and communicate with the service provider server 130 via the network 160. In another implementation, the user interface application 112 includes a browser module that provides a network interface to browse information available over the network 160. For example, the user interface application 112 may be implemented, in part, as a web browser to view information available over the network 160.

The user device 110, in various embodiments, may include other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications. In still other examples, the other applications 116 may interface with the user interface application 112 for improved efficiency and convenience.

The user device 110, in one embodiment, may include at least one identifier 114, which may be implemented, for example, as operating system registry entries, cookies associated with the user interface application 112, identifiers associated with hardware of the user device 110 (e.g., a media control access (MAC) address), or various other appropriate identifiers. The identifier 114 may include one or more attributes related to the user 140 of the user device 110, such as personal information related to the user (e.g., one or more user names, passwords, photograph images, biometric IDs, addresses, phone numbers, social security number, etc.) and banking information and/or funding sources (e.g., one or more banking institutions, credit card issuers, user account numbers, security data and information, etc.). In various implementations, the identifier 114 may be passed with a user login request to the service provider server 130 via the network 160, and the identifier 114 may be used by the service provider server 130 to associate the user with a particular user account maintained by the service provider server 130.

In various implementations, the user 140 is able to input data and information into an input component (e.g., a keyboard) of the user device 110 to provide user information with a transaction request, such as a login request, a fund transfer request, a request for adding an additional funding source (e.g., a new credit card), or other types of request. The user information may include user identification information.

The user device 110, in various embodiments, includes a location component 118 configured to determine, track, monitor, and/or provide an instant geographical location of the user device 110. In one implementation, the geographical location may include GPS coordinates, zip-code information, area-code information, street address information, and/or various other generally known types of location information. In one example, the location information may be directly entered into the user device 110 by the user via a user input component, such as a keyboard, touch display, and/or voice recognition microphone. In another example, the location information may be automatically obtained and/or provided by the user device 110 via an internal or external monitoring component that utilizes a global positioning system (GPS), which uses satellite-based positioning, and/or assisted GPS (A-GPS), which uses cell tower information to improve reliability and accuracy of GPS-based positioning. In other embodiments, the location information may be automatically obtained without the use of GPS. In some instances, cell signals or wireless signals are used. For example, location information may be obtained by checking in using the user device 110 via a check-in device at a location, such as a beacon. This helps to save battery life and to allow for better indoor location where GPS typically does not work.

Even though only one user device 110 is shown in FIG. 1, it has been contemplated that one or more user devices (each similar to user device 110) may be communicatively coupled with the service provider server 130 via the network 160 within the system 100.

The merchant server 120, in various embodiments, may be maintained by a business entity (or in some cases, by a partner of a business entity that processes transactions on behalf of business entity). Examples of business entities include merchant sites, resource information sites, utility sites, real estate management sites, social networking sites, etc., which offer various items for purchase and process payments for the purchases. The merchant server 120 may include a merchant database 124 for identifying available items, which may be made available to the user device 110 for viewing and purchase by the user.

The merchant server 122, in one embodiment, may include a marketplace application 122, which may be configured to provide information over the network 160 to the user interface application 112 of the user device 110. For example, the user 140 of the user device 110 may interact with the marketplace application 122 through the user interface application 112 over the network 160 to search and view various items available for purchase in the merchant database 124.

The merchant server 120, in one embodiment, may include at least one merchant identifier 126, which may be included as part of the one or more items made available for purchase so that, e.g., particular items are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

A merchant may also use the merchant server 120 to communicate with the service provider server 130 over the network 160. For example, the merchant may use the merchant server 120 to communicate with the service provider server 130 in the course of various electronic services offered by the service provider to a merchant, such as providing an online platform that facilitates electronic payment between customers of the merchant and the merchant itself. For example, the merchant server 120 may use an application programming interface (API) that allows it to offer sale of goods or services in which customers are allowed to make electronic payment through the service provider server 130, while the user 140 may have an account with the service provider server 130 that allows the user 140 to use the service provider server 130 for making electronic payments to merchants that allow use of authentication, authorization, and electronic payment services of the service provider. The merchant may also have an account with the service provider server 130. Even though only one merchant server 120 is shown in FIG. 1, it has been contemplated that one or more merchant servers (each similar to merchant server 120) may be communicatively coupled with the service provider server 130 and the user device 110 via the network 160 in the system 100.

The service provider server 130, in one embodiment, may be maintained by a transaction processing entity or an online service provider, which may provide processing for electronic transactions between the user 140 of user device 110 and one or more merchants. As such, the service provider server 130 may include a service application 138, which may be adapted to interact with the user device 110 and/or the merchant server 120 over the network 160 to facilitate the electronic transactions such as searching, selection, purchase, payment of items online, and/or other electronic services offered by the service provider server 130. In one example, the service provider server 130 may be provided by PayPal®, Inc. of San Jose, Calif., USA, and/or one or more service entities or a respective intermediary that may provide multiple point of sale devices at various locations to facilitate transaction routings between merchants and, for example, service entities.

In some embodiments, the service application 138 may include a payment processing application (not shown) for processing purchases and/or payments for electronic transactions between a user and a merchant or between any two entities. In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include a web server 134 that is configured to serve web content to users in response to HTTP requests. As such, the web server 134 may include pre-generated web content ready to be served to users. For example, the web server 134 may store a log-in page, and is configured to serve the log-in page to users for logging into user accounts of the users to access various service provided by the service provider server 130. The web server 134 may also include other webpages associated with the different electronic services offered by the service provider server 130. As a result, a user may access a user account associated with the user and access various services offered by the service provider server 130, by generating HTTP requests directed at the service provider server 130.

In various embodiments, the service provider server includes a decision making module 132 that is configured to determine whether to authorize or deny an incoming request from the user device 110 or from the merchant server 120. In some embodiments, the decision making system as discussed herein may be implemented as the decision making module 132. The request may be a log-in request, an electronic fund transfer request, a request for adding an additional funding source, or other types of electronic transaction requests associated with the variety of services offered by the service provider server 130. As such, when a new request is received at the service provider server 130 (e.g., by the web server 134), the decision making module 132 may analyze (or evaluate) the request and determine whether the request is possibly an unauthorized/fraudulent request based on information available to the decision making module 132. The decision making module 132 may transmit an indication of whether the request is possibly an unauthorized/fraudulent request to the web server 134 and/or the service application 138 such that the web server 134 and/or the service application 138 may process (e.g., approve or deny) the request based on the indication.

The service provider server 130, in one embodiment, may be configured to maintain one or more user accounts and merchant accounts in an account database 136, each of which may include account information associated with one or more individual users (e.g., the user 140 associated with user device 110) and merchants. For example, account information may include private financial information of users and merchants, such as one or more account numbers, passwords, credit card information, banking information, digital wallets used, or other types of financial information, transaction history, Internet Protocol (IP) addresses, device information associated with the user account, which may be used by the decision making module 132 to determine whether to authorize or deny a request associated with the user account. In certain embodiments, account information also includes user purchase profile information such as account funding options and payment options associated with the user, payment information, receipts, and other information collected in response to completed funding and/or payment transactions.

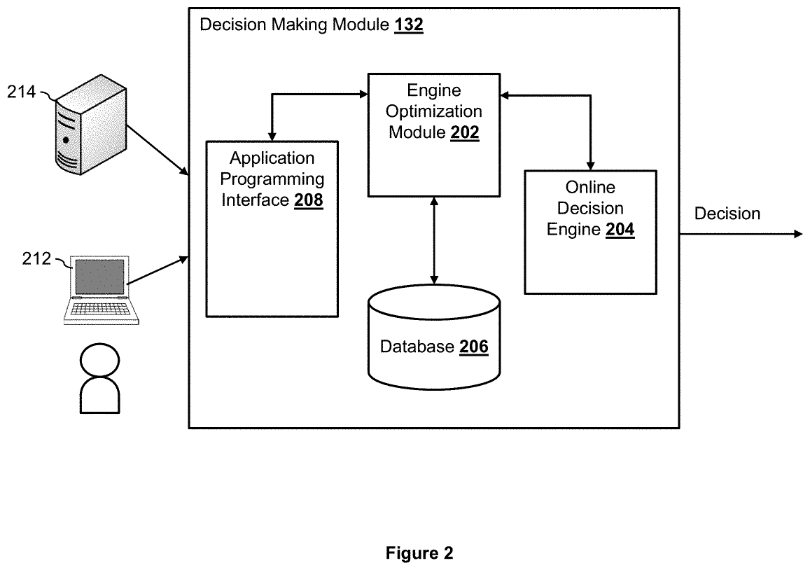

FIG. 2 illustrates a block diagram of the decision making module 132 according to an embodiment of the disclosure. The decision making module 132 includes an engine optimization module 202, an online decision engine 204, a database 206, and an application programming interface 208. In some embodiments, the online decision engine 204 is a computer-based rule engine and may include multiple different sets of rules (decision making algorithms) for evaluating a transaction request. In some embodiments, the decision making module 132 may receive a request, via the application programming interface 208, for example, from the web server 134. The request may correspond to an electronic transaction request initiated by the user 140, and may require a response based on a decision (or outcome) generated by the decision making module 132. For example, the request may be a user login request received by the web server 134, and the web server 134 may be required to grant or deny the request based on a decision generated by the online decision engine 204. As such, when the request is received by the decision making module 132, the online decision engine 204 may use at least some of the different decision making algorithms to evaluate the transaction request in order to generate a decision (e.g., an outcome). The decision making module 132 may then pass the decision to the web server 134 such that the web server 134 may process the request accordingly. As discussed above, in some embodiments, the online decision engine 204 may also log information related to evaluating the request (also known as activity data) in a logged file. The logged information may include data extracted from the request (e.g., a type of request, an identity of a user account associated with the request, a time that the request was made, the IP address of a device that initiates the request, etc.) and data retrieved from other sources such as from the accounts database 136 (e.g., electronic transaction history of the user account, etc.) and/or from external sources. In some embodiments, since the online decision engine is required to process requests in real-time, the online decision engine may store the activity data in an unstructured format (e.g., a text stream) in the logged file.

In some embodiments, the online decision engine 204 is implemented in a business rule management system (BRMS) such as IBM® ILOG® platform. The BRMS may support executing decision making rule(s) implemented in one or more programming language. The programming languages supported by the BRMS may include imperative programming languages such as C#, C++, Java, etc., that can be compiled and executed to perform the logic associated with the decision making algorithms. In these embodiments, the decision making module 132 may modify the online decision engine 204 by obtaining programming codes that implement a new decision making algorithm in one of the supported programming languages. For example, the programming codes may be written by a software developer and received from a computing device 212 via the application programming interface 208. The programming codes may also be generated autonomously by a computing device (e.g., a server) 214, and received via the application programming interface 208.

In some embodiments, the online decision engine 204 may assign an operating state (e.g., an active state or an inactive state) to each of the decision making algorithms within the online decision engine 204. Active decision making algorithms are algorithms currently utilized by the online decision engine 204 in evaluating incoming requests. On the other hand, inactive decision making algorithms are not currently being utilized by the online decision engine 204 in evaluating incoming requests. The inactive decision making algorithms may have been active in the past, but were turned into an inactive state based on factors such as a change of a trend (e.g., the type of fraudulent schemes that the decision making algorithm was used to detect is no longer popular), replaced by a newer version of the decision making algorithm, etc. In these embodiments, the decision making module 132 may modify (e.g., re-configure) the online decision engine 204 by changing the state of a decision making algorithm within the online decision engine 204.

In some embodiments, a decision making algorithm may include a threshold value. For example, the decision making algorithm may use the information retrieved for the request to compute a value (e.g., a confidence score), and may generate a decision based on the calculated value in relation to the threshold. In one example, the decision making algorithm may generate a decision that indicates a denial of the request when the confidence score is below the threshold, and generate a decision that indicates an authorization of the request when the confidence score is above the threshold. In these embodiments, the decision making module 132 may modify (e.g., re-configure) the online decision engine 204 by adjusting the threshold value of at least one of the decision making algorithms.

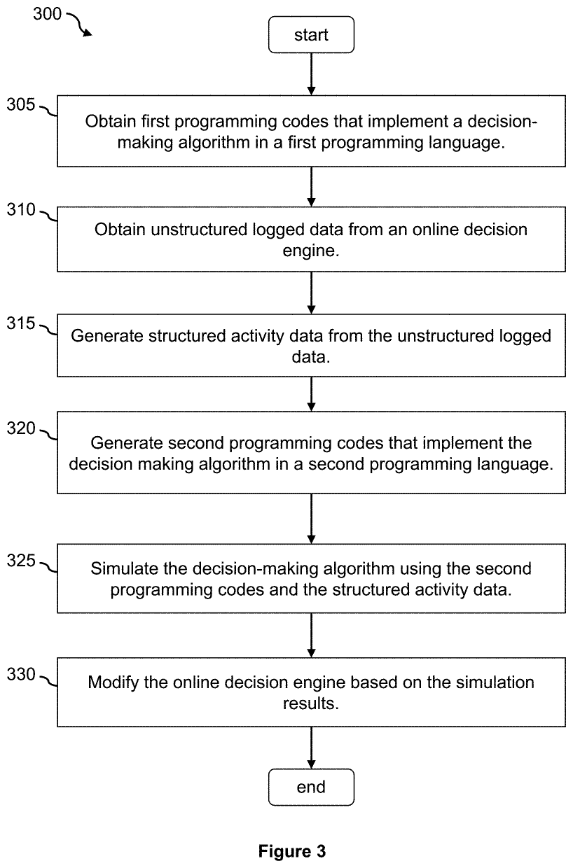

In some embodiments, the engine optimization module 202 may use online activity data collected by the online decision engine 204 to run simulations of one or more decision making algorithms to generate simulation results, and modify (e.g., reconfigure) the online decision engine 204 based on the simulation results. FIG. 3 illustrates a process 300 for performing simulations of one or more decision making algorithms using online activity data to modify (e.g., reconfigure) an online decision engine according to an embodiment of the disclosure. In some embodiments, the process 300 may be performed by the decision making module 132. The process 300 begins by obtaining (at step 305) first programming codes that implement a decision making algorithm in a first programming language. As discussed above, the decision making module 132 may obtain the first programming codes in different ways. In some embodiments, a new decision making algorithm may be generated for use by the online decision engine 204. Before putting the decision making algorithm in use in the online decision engine 204, the decision making module 132 may first evaluate the new decision making algorithm, for example, by performing a simulation on a new decision making algorithm. For example, a human software developer may create the first programming codes that implement a decision making algorithm in a programming language supported by the online decision engine 204, to be used by the online decision engine 204. The decision making module 132 may receive the first programming codes generated by the human software developer via the interface 208. In another example, the first programming codes may be generated autonomously by a computing device (e.g., the server 214). Similarly, the decision making module 132 may receive the first programming codes generated by the computer server 214 via the application programming interface 208.

In some embodiments, the decision making module 132 may periodically (e.g., every week, every month, etc.) evaluate one or more decision making algorithms (for example, by performing a simulation of the decision making algorithms) already implemented in the online decision engine 204. As such, the decision making module 132 may retrieve the first programming codes directly from the online decision engine 204. As discussed above, the online decision engine 204 may include one or more decision making algorithms (implemented in the programming language supported by the online decision engine 204). For example, the online decision engine 204 may include a decision tree that includes multiple decision making algorithms. As a request is received the online decision engine 204 may evaluate the request by traversing the decision tree, and execute the decision making algorithms along the traversed path.

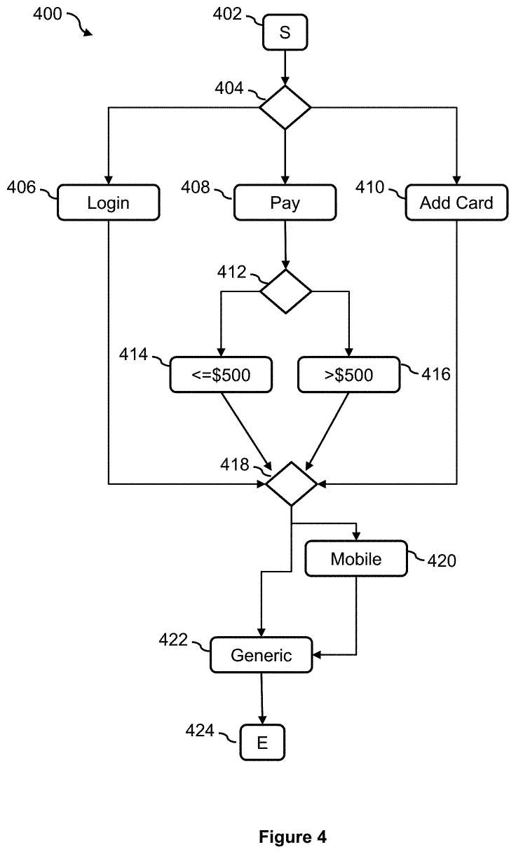

FIG. 4 illustrates an exemplary decision tree 400 implemented by an online decision engine according to an embodiment of the disclosure. The decision tree 400 includes a start node 402 and an end node 424. When a transaction request is received, the online decision engine 204 may begin the evaluation at the start node 402. The start node 402 is connected to only one node 404, so the rule engine 206 may continue along the path to traverse the node 404. The node 404 is connected to three different successor nodes 406, 408, and 410. As such, the online decision engine 204 may use information related to the transaction request to assess a set of conditions of the node 404. Based on the result from assessing the set of conditions of the node 404, the online decision engine 204 may take a path that leads to the node 406, a path that leads to the node 408, or a path that leads to the node 410. In this example, the set of conditions may include a condition of whether the transaction request is a login request, a condition of whether the transaction request is a payment transaction request, and a condition of whether the transaction request is a request to add a funding source to a user account. When it is determined that the transaction request is a login request, the online decision engine 204 may take the path that leads to the node 406.

In some embodiments, the node 406 may be associated with a decision making algorithm. As such, the online decision engine 204 may execute the decision making algorithm using the information related to the transaction request. The decision making algorithm may generate a decision that indicates to the online decision engine 204 to either deny the request or move forward along the decision path. If the decision is to deny the request, the online decision engine 204 may exit the decision tree 400 and generate a decision that indicates a denial of the request. After the node 406, the path leads to the node 418. Similar to the node 404, the node 418 is connected to more than one successor node. In this example, the node 418 is connected to two nodes: a node 420 and a node 422. As such, the online decision engine 204 may use the information related to the transaction request to assess a set of conditions of the node 418. Based on the result from assessing the set of conditions of the node 418, the online decision engine 204 may take a path that leads to the node 420 or a path that leads to the node 422. In this example, the set of conditions may include a condition of whether the transaction request is initiated from a mobile device or not. When it is determined that the transaction request is not initiated from a mobile device, the online decision engine 204 may take the path that leads to the node 422. The node 422 may be associated with another decision making algorithm, and the online decision engine 204 may execute the decision making algorithm of the node 422 using the information related to the transaction request. Similar to the node 406, the decision making algorithm may generate a decision that indicates to the online decision engine 204 whether to deny the request or move along the path. If the decision is to deny the request, the online decision engine 204 may exit the decision tree 400. The online decision engine 204 then reaches the end node 424. In some embodiments, when the online decision engine 204 reaches the end node 424, the online decision engine 204 may generate a decision to authorize the transaction request, as it has passed all of the decision making algorithms along the traversed path.

Similar to the nodes 406 and 422, each of the nodes 408, 410, 414, 416, and 420 is also associated with a decision making algorithm. The online decision engine 204 would execute the corresponding decision making algorithm as it traverses each of these nodes in evaluating a transaction request. As such, referring back to the node 404, when it is determined that the transaction request is a payment transaction request, the online decision engine 204 may take the path that leads to the node 408 (where the online decision engine 204 would execute the decision making algorithm of the node 408 with the information related to the transaction request, and would exit the decision tree 400 when the decision making algorithm generates a decision that indicates a denial of the request). After the node 408, the path then reaches the node 412, which connects to two different nodes —414 and 416. As such, the rule engine 206 may use information related to the transaction request to assess a set of conditions of the node 412. Based on the result from assessing the set of conditions of the node 412, the online decision engine 204 may take a path that leads to the node 414 or a path that leads to the node 416. In this example, the set of conditions may include a condition of whether the payment transaction request involves an amount that is larger than $500. When it is determined that the payment transaction request involves an amount larger than $500, the rule engine 206 may take the path that leads to the node 416 (where the online decision engine 204 would execute the decision making algorithm of the node 416 with the information related to the transaction request, and would exit the decision tree 400 when the decision making algorithm generates a decision that indicates a denial of the request), which leads to the node 418. The online decision engine 204 then performs similar process as described above before reaching the end node 424, at which point, the online decision engine may generate a decision that indicates authorizing the request.

On the other hand, if it is determined that the payment transaction request involves an amount that is less than or equal to $500, the online decision engine 204 may take the path that leads to the node 414 (where the online decision engine 204 would execute the decision making algorithm of the node 414 with the information related to the transaction request, and would exit the decision tree 400 when the decision making algorithm generates a decision that indicates a denial of the request), which leads to the node 418. The online decision engine 204 then performs similar process as described above before reaching the end node 424, at which point, the rule engine may generate a decision that indicates authorizing the request.

Referring back to the node 404, when it is determined that the transaction request is a request for adding an additional funding source, the online decision engine 204 may take the path that leads to the node 410 (where the online decision engine 204 would execute the decision making algorithm of the node 410 with the information related to the transaction request, and would exit the decision tree 400 when the decision making algorithm generates a decision that indicates a denial of the request), which leads to the node 418. The rule engine 206 then performs a similar process as described above before reaching the end node 424, at which point, the rule engine may generate a decision that indicates authorizing the request.

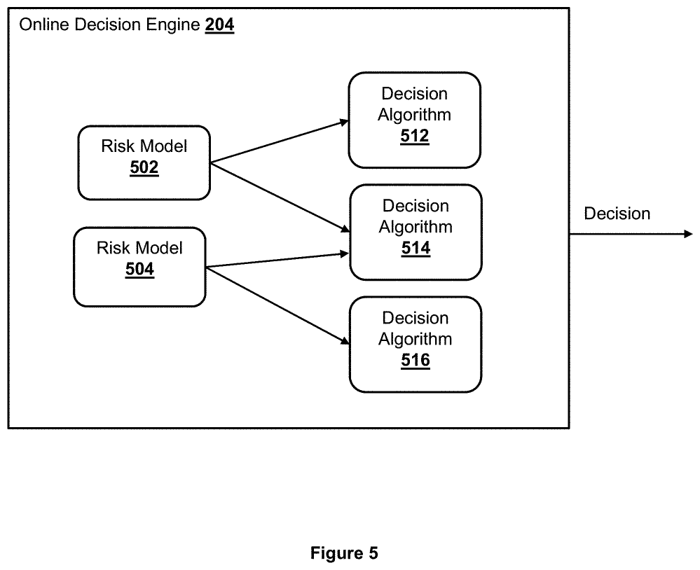

The decision making algorithms within the decision tree 400 may use one or more risk models to generate the decision. FIG. 5 illustrates a block diagram of the online decision engine 204 according to an embodiment of the disclosure. The online decision engine 204 may include decision algorithms 512, 514, and 516, at least some of which may be implemented within the decision tree 400. The online decision engine 204 may also include risk models 502 and 504. Each of the risk models 502 and 504 may be computer-based model, such as a machine learning model. The machine learning model may be implemented as an artificial neural network, for example. Each of the risk models 502 and 504 may be configured to accept a set of input values (e.g., values that can be derived from the information related to a transaction request) and generate an output. The output maybe a numerical value (e.g., a confidence score). As shown, a decision algorithm (e.g., the decision algorithm 514) may utilize more than one risk model. Further, some of the decision algorithms may share the same risk model. For example, the decision algorithms 512 and 514 both utilize the risk model 502, and the decision algorithms 514 and 516 both utilize the risk model 504. In some embodiments, the decision algorithms that share the same risk model may use the risk model differently. For example, the decision algorithms 512 and 514 may have different threshold values such that the same output generated by the risk model 502 may result in different decisions generated by the decision algorithms 512 and 514. In addition, the decision algorithm 514 may generate the decision based on the output values from both of the risk models 502 and 504.

As such, the decision making module 132 may retrieve first programming codes corresponding to one (or more) of the decision making algorithms (e.g., the decision algorithms 512-516) within the decision tree 400. The decision making algorithm corresponding to the first programming code may be an active algorithm or an inactive algorithm. The simulation may enable the decision making module 132 to optimize the performance of the online decision engine 204 by periodically modifying (e.g., re-configuring) the online decision engine 204.

In one example, the first programming codes may be expressed as:

```
definitions
    set ‘is_a0’ to iif ( _VAR value of variable ( “a00x” ) equals “1” ?
True “1” : False “0” );
If
    any of the following conditions is true :
        - ‘is_a0’ equals “0”
        -_VAR value of variable ( “a1” ) to decimal is at least 30
        -_VAR value of variable ( “b2” ) to decimal is at least 101
        - all of the following conditions are true :
            -_VAR value of variable ( “c3” ) equals “15_OP”
            -_ATTR critical attribute is at least 100,,
    and ‘_ENV’ sub attr number equals “120”
then
    Action;
```

At step 310, the process 300 obtains unstructured logged data from an online decision engine. As discussed above, the online decision engine 204 of some embodiments may log activity data related to processing incoming requests. For example, the online decision engine 204 may log data associated with a request, and all of the information used by the online decision engine 204 to evaluate the request (e.g., a type of request, an identity of a user account associated with the request, a time that the request was made, the IP address of a device that initiates the request, electronic transaction history of the user account, a number of successful transactions associated the user account within a predetermined period of time, a number of failed transactions associated with the user account within the predetermined period of time, a time, a browser type, a device type, etc.) in a data log. Since the online decision engine 204 is required to process a large volume of requests online (in real-time), the online decision engine 204 of some embodiments may log the data in an unstructured format (e.g., in a text stream). In order the make use of the activity data in the data log, the data may be formatted/organized by the engine optimization module 202.

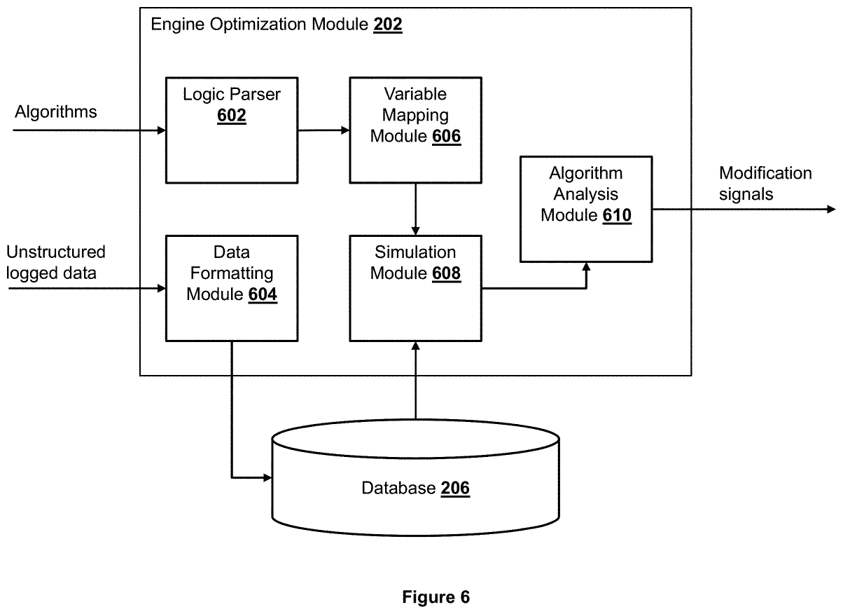

Thus, the process 300 generates (at step 315) structured activity data from the unstructured logged data. For example, the engine optimization module 202 may generate structured activity data based on the data log generated by the online decision engine 204. FIG. 6 illustrates a block diagram of the engine optimization module 202 according to one embodiment of the disclosure. The engine optimization module 202 includes a logic parser 602, a data formatting module 604, a variable mapping module 606, a simulation module 608, and an algorithm analysis module 610. For example, the data formatting module 604 may receive the unstructured logged data, generate the structured activity data, and store the structured activity data in the database 206.

In some embodiments, the data formatting module 604 may generate (or obtain) a data structure for storing data (e.g., variables) related to the transaction requests within the database system 206. In some embodiments, the data structure may include one or more tables, variable names, and variable types corresponding to the variable names. The data structure may also be implemented in a relational database system (RDBS) (in these embodiments, the database system 206 is an RDBS). The data structure may also be implemented in a platform (e.g., Hadoop®) that is designed to process big data (in these embodiments, the database system 206 comprises the big data processing platform such as Hadoop®). In some of these embodiments, the data structure may be accessed directly via a query language (e.g., a structured query language (SQL), etc.).

While the logged data is unstructured, the online decision engine 204 may follow a set of logging rules to log the data when processing/evaluating transaction requests. In some embodiments, the online decision engine 204 may follow a specific order of data types in logging the data. For example, the online decision engine 204 may write into the data log information related to different transaction requests. For each transaction request, the online decision engine 204 may write the information related to the transaction request in the predetermined order of the data fields. In an example where the transaction request is a login request, the predetermined order of the logged data may include: a transaction type of the request, an identity of a user account associated with the request, a time that the request was made, the IP address of a device that initiates the request, a number of successful logins in the past six months, a number of failed logins in the past six months, a browser type of a browser that initiated the request, and a device type of the device that initiates the request. The data may be written into the data log by the online decision engine 204 in such an order, where each variable separated may be by a predetermined character (e.g., a space character, etc.).

As such, in some embodiments, the data formatting module 604 may use the set of logging rules to extract variables from the data log and store the variables in the corresponding data field (variable type) in the data structure. It is noted that the online decision engine 204 may continue to receive/process requests, and continuously log the information related to the requests to the data log. As such, the data formatting module 604 may retrieve new logged data in real time, or periodically (e.g., every few seconds, every minute, every half a minute, every five minutes, etc.), and insert the new activity data into the data structure in the same manner discussed above. Thus, the data structure may include new activity data (online data) as requests are processed and activity data is logged by the online decision engine 204. When the formatting of activity data is performed sufficiently frequent (e.g., every minute, every five minutes), the structured activity data (e.g., the data stored in the data structure) represents online data.

The process 300 then generates (at step 320) second programming codes that implement the decision making algorithm in a second programming language. In this regard, when the engine optimization module 202 obtains the first programming codes that implement the decision making algorithm in the first programming language, the logic parser 620 may parse the first programming code (in a similar manner that a compiler parses programming codes as the compiler compiles the codes) using the syntax rules corresponding to the first programming language. As discussed above, the first programming language may be one of the programming languages supported by the online decision engine 204. As such, the first programming language may be an imperative language that can be compiled and executed. The first programming language may also be an object-oriented programming language such as C++, Java, etc. In some embodiments, the logic parser 602 may generate an abstract syntax tree representing the logic of the decision making algorithm, and may then generate second programming codes in the second programming language based on the abstract syntax tree.

In the example given above, the logic parser 602 may generate the following abstract syntax tree based on the first programming codes:

```
stmt_list([
    def_stmt(set_stmt_list([
        set_stmt(is_a0, iff_expr(cond:equals(_VAR value
    of variable ( “a00x” ), “1”), tresult:“1”, fresult:“0”))
    ])),
    if_stmt(
        logic_expr(and,
            grp_cond_expr(any of the following conditions is true,
        grp_cond_expr_list([
                equals (is_1st_pmt,“0”),
                is at least(converted_expr(expr= _VAR value
            of variable (“ a1”), type=‘decimal’),30),
                is at least(converted_expr(expr= _VAR value
            of variable (“ b2”), type=‘decimal’),101),
                grp_cond_expr(all of the following conditions are
            true,grp_cond_expr_list([
                    equals(_VAR value of variable ( “C3” ),
                    “15OP ”), is at least(_ATTR critical attribute,
                    100)]))]
                )
            ),
            equals(‘_ENV’ sub attr number,“120”)
        )
    )
)]
```

As discussed above, the second programming language may be a language that can be used to directly access the data structure. For example, when the data structure is implemented in a database (e.g., an RDBS), the second programming language may be a query language (e.g., SQL, one of the variations of the SQL language such as Spark SQL, etc.).

In the example given above, the logic parser 602 may generate the following second programming codes:

```
SELECT CASE
      WHEN a0 = “1” THEN “1”
      ELSE “0”
    END AS a0,
    a1,
    b2,
    c3,
    d4,
    Cast(e500 AS DOUBLE) AS e5
FROM test_db.test_table
WHERE ( ( a0 = “0”
      OR a1 >= 30
      OR b2 >= 101
      OR ( c3 = “15op”
        AND d4 >= 300 ) )
      AND e5 = “120” )
```

Since the second programming codes are derived from the first programming codes written for the online decision engine 204, the variable names used in the second programming codes remain the same as those names used in the first programming codes. These variable names may be specifically used by the online decision engine 204, and may not match the variable names (e.g., field names) of the data structure generated by the data formatting module 604. As such, in order for the second programming codes to be compatible with the data structure, in some embodiments, the decision making system may map the variable names in the first programming codes to the corresponding variable names in the data structure during or after logging process. The decision making system may then use mapped variables in the second programming codes such that the second programming codes may be properly executed on the data structure. Alternatively, the variable mapping module 606 may analyze the second programming codes to map the variable names in the second programming codes to the corresponding variable names (e.g., field names) in the data structure. The variable mapping module 606 may then modify the variable names referred in the second programming codes to match the variable names used in the data structure, such that the second programming codes may be properly executed on the data structure.

Table 1 below illustrates an example mapping table that specifies the necessary transformation to the variable names in the second programming codes to make the codes compatible with the data structure. In Table 1, the first column (the left-most column) lists variable names expressed in the online decision engine 204, the second column (the middle column) lists the corresponding variable names in the data structure, and the third column (the right-most column) provides the transformation operation that can be performed on the second programming codes to modify the variable names expressed in the second programming codes to make the codes compatible with the data structure.

TABLE 1
Variable Mapping

| Expression in Decision | Variable logged in Big | |
|---|---|---|
| Engine | Data Platform | Transformation |
| _VAR value of variable | a0 | |
| (“a00x”) | | |
| _VAR value of variable | a1 | |
| (“a1”) | | |
| _VAR value of variable | b2 | |
| (“b2”) | | |
| _VAR value of variable | c3 | |
| (“c3”) | | |
| _ATTR critical attribute | d4 | |
| ‘_ENV’ sub attr number | e500 | CAST(E500 AS |
| | | DOUBLE)/100 AS e5 |

After the second programming codes are generated, the process 300 simulates (at step 325) the decision making algorithm using the second programming codes and the structured activity data. For example, the simulation module 608 may perform a simulation by executing the second programming codes. In some embodiments, the second programming language (e.g., SQL, etc.) provides an interface for directly accessing the database system 206. As such, the simulation module 608 may use the second programming codes to directly access the data stored the database system 206, for example, by executing the second programming codes on the database system 206. As discussed above, the data structure may include logged activity data related to requests received by the online decision engine 204 from a historic time (e.g., the time since the data formatting module 604 begins converting logged data such as 1 year ago, 5 years ago, etc.) to requests received by the online decision engine 204 as recent as the current moment. Since trends of fraudulent techniques change from time to time, the simulation module 608 may determine a time frame (e.g., the past two weeks, the past six months, the past year, etc.) within which requests are used for the simulation, and execute the second programming codes only on the structured activity data related to requests within such a time frame.

In some embodiments, in addition to executing the second programming codes, the simulation module 608 may also generate metrics based on applying the decision making algorithm on the sample requests represented by the structured activity data stored in the data structure (e.g., in the database system 206). For example, the metrics may indicate a number of requests being denied based on the decision making algorithm, a percentage of the requests being denied based on the decision making algorithm, a false positive rate (e.g., the percentage of transactions determined to be fraudulent by the simulation are instead legitimate transactions), a false negative rate (e.g., the percentage of transactions determined to be legitimate transactions by the simulation are instead fraudulent transactions), or any other metrics that may be useful in evaluating the effectiveness of the decision making algorithm.

The metrics may be used by the simulation module 608 to generate simulation results, which may then be analyzed by the algorithm analysis module 610. Different embodiments of the algorithm analysis module 610 may use different ways to evaluate a decision making algorithm based on the simulation results. For example, the algorithm analysis module 610 of some embodiments may determine whether the metrics generated based on the simulation is within a predetermined range of values. In one example, the algorithm analysis module 610 may determine that the decision making module is effective when the percentage of requests being denied is between 10% and 20%. In some embodiments, the algorithm analysis module 610 may determine to discard the decision making algorithm when the percentage of requests being denied is outside of the predetermined acceptable range.

After performing the simulation, the process 300 then modifies (at step 330) the online decision engine. In some embodiments, the algorithm analysis module 610 may generate modification signals for modifying the online decision engine 204 based on analyzing the simulation results. For example, when the algorithm analysis module 610 determines that the decision making algorithm is effective based on the simulation results (e.g., the percentage of requests being denied is within a predetermined acceptable range, etc.), the algorithm analysis module 610 may generate modification signals for incorporating the decision making algorithm in the online decision engine 204. In some embodiments, the modification signals include signals for adding the first programming codes in the source codes of the online decision engine 204. The modification signals then cause the decision making algorithm (implemented in the first programming language) to be incorporated into the online decision engine 204 such that subsequent incoming requests would be evaluated with the decision making algorithm.

As discussed herein, the decision making algorithm of some embodiments include a threshold value. For example, the decision making algorithm may generate (e.g., using one or more of the risk models 502 and 504) a score (e.g., a confidence score) based on information related to a request. The decision making algorithm may generate a decision (e.g., whether to authorize or deny the request, etc.) based on the score in relation to the threshold. In one example, the decision making algorithm may generate a decision for authorizing the request when the score is above the predetermined threshold, and may generate a decision for denying the request when the score is below the predetermined threshold. In some embodiments, instead of performing a single simulation of the decision making algorithm, the simulation module 608, at the step 325, may perform multiple simulations for the decision making algorithm, each simulation using a different threshold value.

For example, the engine optimization module 202 may analyze the decision making algorithm (e.g., by analyzing the abstract syntax tree). When the engine optimization module 202 determines that the decision making algorithm utilizes a threshold value to generate the decision, the simulation module 608 may generate different versions of the second programming codes, each version with a different threshold value. For example, the simulation module 608 may determine the different threshold values based on the initial threshold value used in the decision making algorithm. In one example, the simulation module 608 may generate threshold value variations that are a predetermined percentage (e.g., 5%, 10%, 15%, etc.) above and/or below the initial threshold value, and may use these variations in the different versions of the second programming codes.

The simulation module 608 may then perform simulations on the different versions of the decision making algorithm by executing the different versions of the second programming codes on the database system 206. In some embodiments, the simulation module 608 may also generate metrics for the different simulations in the same manner as discussed herein. The algorithm analysis module 610 may then compare the metrics generated based on the different simulations and determine an optimal threshold value based on analysis of the metrics. For example, the algorithm analysis module 610 may use the threshold value that generates the denial percentage closest to a predetermined optimal denial percentage value. Other methods may also be used to determine the optimal threshold value. Once the optimal threshold value is determined, the algorithm analysis module 610 may modify the first programming codes with the optimal threshold value, and may generate the modification signals for incorporating the modified first programming codes into the online decision engine 204.

In some embodiments, the decision making algorithm is a newer version (e.g., Version 2.0) of another decision making algorithm (e.g., Version 1.0) that has already been implemented within the online decision engine 204. In these embodiments, the engine optimization module 202 may, in addition to simulating the decision making algorithm received via the application programming interface 208, retrieve (or extract) programming codes from the online decision engine 204 corresponding to the Version 1.0 algorithm and simulate the Version 1.0 algorithm. The simulation module 608 may generate metrics for both of the simulations in the same manner discussed herein. The algorithm analysis module 610 may analyze (e.g., compare) the metrics (simulation results) to determine which version is more effective. For example, the algorithm analysis module 610 may determine that one version is more effective when the metrics generated by that one version is closer to a predetermined optimal value than the metrics generated by the other version. If the newer version (e.g., Version 2.0) is determined to be more effective than the older version (e.g., Version 1.0), the algorithm analysis module 610 may generate modification signals for modifying the online decision engine 204 by replacing the programming codes corresponding to the older version of the decision making algorithm with the first programming codes (corresponding to the newer version of the decision making algorithm). The online decision engine 204 may then utilize the newer version of the decision making algorithm for evaluating subsequent incoming requests.

In some embodiments, instead of or in addition to simulating decision making algorithms that are received through the application programming interface 208, the engine optimization module 202 may periodically (e.g., every day, every week, every month, etc.) simulate decision making algorithms that are already implemented within the online decision engine 204. In some embodiments, the engine optimization module 202 may periodically simulate both active and inactive decision making algorithms in the online decision engine 204. For example, the engine optimization module 202 may retrieve (or extract) the programming codes (from the source code of the online decision engine 204) corresponding to each decision making algorithm, may use the same process discussed herein to simulate the decision making algorithm to generate metrics (e.g., simulation results). The algorithm analysis module 610 may modify the online decision engine 204 based on the simulation results generated by simulating the decision making algorithms. For example, when the algorithm analysis module 610 determines that an active decision making algorithm is not effective (e.g., the metrics generated by simulating the active decision making algorithm is outside of a predetermined acceptable range, etc.), the algorithm analysis module 610 may generate modification signals for switching the operating state of the decision making algorithm from an active operating state to an inactive operating state.

In another example, when the algorithm analysis module 610 determines that an inactive decision making algorithm is effective (e.g., the metrics generated by simulating the inactive decision making algorithm is within a predetermined acceptable range, etc.), the algorithm analysis module 610 may generate modification signals for switching the operating state of the decision making algorithm from an inactive operating state to an active operating state.

For a decision making algorithm that uses a threshold value to generate a decision, the simulation module 608 may simulates different versions of the decision making algorithms (by varying the threshold values in the manner discussed herein). The algorithm analysis module 610 may analyze (e.g., compare) the simulation results generated by the different versions of the decision making algorithms and may select a threshold value the produces the optimal simulation results (e.g., generates the metrics closest to a predetermined optimal metric value). The algorithm analysis module 610 may then generate modification signals for adjusting the decision making algorithm with the selected threshold value (e.g., by modifying the programming codes corresponding to the decision making algorithm in the online decision engine 204). It is noted that the simulation module 608 can also determine and set a time frame within which activity data is used for these simulations.

The decision making module 132 does not require a human software developer who develops a decision making algorithm for the online decision engine 204 to implement the decision making algorithm in more than one programming language for simulation and incorporation into the online decision engine 204. The decision making module 132 advantageously reduces the potential to have errors (e.g., or variations between multiple implementations of the decision making algorithm) and the time it takes to deploy the decision making algorithm. Furthermore, since the simulation of the decision making algorithm may be performed based on data that includes online activity data, the decision making algorithm may be evaluated based on the most recent trend, which advantageously improves the effectiveness and performance of the online decision engine. In addition, since the decision making module 132 may periodically simulate existing decision making algorithms, the decision making module 132 may continue to fine-tune the online decision engine 204 to further improve its effectiveness and performance.

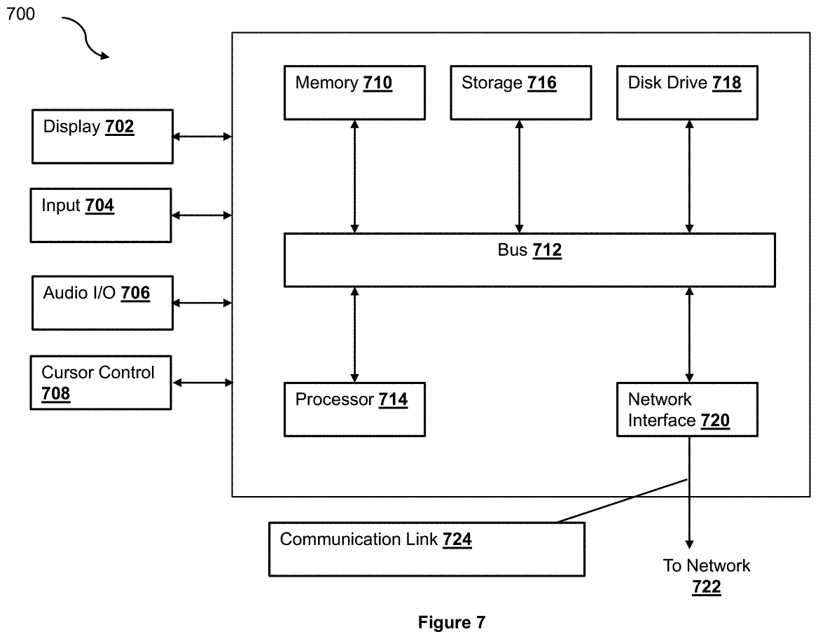

FIG. 7 is a block diagram of a computer system 700 suitable for implementing one or more embodiments of the present disclosure, including the service provider server 130, the merchant server 120, and the user device 110. In various implementations, the user device 110 may include a mobile cellular phone, personal computer (PC), laptop, wearable computing device, etc. adapted for wireless communication, and each of the service provider server 130 and the merchant server 120 may include a network computing device, such as a server. Thus, it should be appreciated that the devices 110, 120, and 130 may be implemented as the computer system 700 in a manner as follows.

The computer system 700 includes a bus 712 or other communication mechanism for communicating information data, signals, and information between various components of the computer system 700. The components include an input/output (I/O) component 704 that processes a user (i.e., sender, recipient, service provider) action, such as selecting keys from a keypad/keyboard, selecting one or more buttons or links, etc., and sends a corresponding signal to the bus 712. The I/O component 704 may also include an output component, such as a display 702 and a cursor control 708 (such as a keyboard, keypad, mouse, etc.). The display 702 may be configured to present a login page for logging into a user account or a checkout page for purchasing an item from a merchant. An optional audio input/output component 706 may also be included to allow a user to use voice for inputting information by converting audio signals. The audio I/O component 706 may allow the user to hear audio. A transceiver or network interface 720 transmits and receives signals between the computer system 700 and other devices, such as another user device, a merchant server, or a service provider server via network 722. In one embodiment, the transmission is wireless, although other transmission mediums and methods may also be suitable. A processor 714, which can be a micro-controller, digital signal processor (DSP), or other processing component, processes these various signals, such as for display on the computer system 700 or transmission to other devices via a communication link 724. The processor 714 may also control transmission of information, such as cookies or IP addresses, to other devices.

The components of the computer system 700 also include a system memory component 710 (e.g., RAM), a static storage component 716 (e.g., ROM), and/or a disk drive 718 (e.g., a solid state drive, a hard drive). The computer system 700 performs specific operations by the processor 714 and other components by executing one or more sequences of instructions contained in the system memory component 710. For example, the processor 714 can perform the risk analysis functionalities described herein according to the process 300.

Logic may be encoded in a computer readable medium, which may refer to any medium that participates in providing instructions to the processor 714 for execution. Such a medium may take many forms, including but not limited to, non-volatile media, volatile media, and transmission media. In various implementations, non-volatile media includes optical or magnetic disks, volatile media includes dynamic memory, such as the system memory component 710, and transmission media includes coaxial cables, copper wire, and fiber optics, including wires that comprise the bus 712. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 700. In various other embodiments of the present disclosure, a plurality of computer systems 700 coupled by the communication link 724 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A method comprising:
obtaining first programming codes that implement a decision-making algorithm in a first programming language corresponding to an online decision engine;
generating second programming codes that implement the decision-making algorithm in a second programming language based on the first programming codes, wherein the second programming language provides an interface for directly accessing a database system;
performing a simulation of the decision making algorithm by executing the second programming codes to directly access the database system to generate simulation results; and
in response to performing the simulation, automatically modifying the online decision engine based on the simulation results.

2. The method of claim 1, further comprising:
obtaining online activity data logged by the online decision engine, wherein the online activity data is unstructured; and
formatting the online activity data to generate a set of structured activity data.

3. The method of claim 2, wherein performing the simulation comprises executing the second programming codes on the set of structured activity data.

4. The method of claim 2, wherein formatting the online activity data comprises parsing the online activity data according to a logging rule associated with the online decision engine to derive the set of structured activity data.

5. The method of claim 1, wherein the simulation of the decision making algorithm is performed on a set of structured activity data derived from online activity data logged by the online decision engine, and wherein generating the second programming codes comprises:
mapping a first variable name corresponding to the first programming codes to a second variable name corresponding to the set of structured activity data.

6. The method of claim 1, wherein generating the second programming codes comprises:
parsing the first programming codes to generate an abstract syntax tree that represents the decision-making algorithm; and
generating the second programming codes based on the abstract syntax tree.

7. The method of claim 1, wherein the decision making algorithm is an inactive algorithm in the online decision engine, wherein modifying the online decision engine comprises:
activating the decision making algorithm in the online decision engine based on the simulation results.

8. The method of claim 1, wherein the decision making algorithm is associated with a threshold value, wherein modifying the online decision engine comprises:
automatically adjusting the threshold value associated with the decision-making algorithm in the online decision engine based on the simulation results.

9. A system comprising:
a non-transitory memory; and
one or more hardware processors communicatively coupled with the non-transitory memory and configured to read instructions from the non-transitory memory to cause the system to perform operations comprising:
obtaining first programming codes that implement a decision-making algorithm in a first programming language corresponding to an online decision engine;
generating second programming codes that implement the decision-making algorithm in a second programming language based on the first programming codes, wherein the second programming language is a query language that enables direct access of a database system;
performing a simulation of the decision making algorithm by directly accessing the database system using the second programming codes to generate simulation results; and
in response to performing the simulation, automatically modifying the online decision engine based on the simulation results.

10. The system of claim 9, wherein the online decision engine is configured to generate a binary decision based on an electronic transaction request.

11. The system of claim 9, wherein the first programming codes are obtained from a computing device over a network.

12. The system of claim 9, wherein the first programming codes are obtained by extracting programming codes corresponding to the decision making algorithm from the online decision engine.

13. The system of claim 1, wherein the operations further comprise:
modifying the decision making algorithm to produce a modified decision making algorithm;
generating third programming codes that implement the modified decision making algorithm in the second programming language; and
performing a simulation of the modified decision making algorithm using the third programming codes to generate second simulation results.

14. The system of claim 13, further comprising:
replacing the decision making algorithm with the modified decision making algorithm in the online decision engine based on the second simulation results.

15. The system of claim 13, wherein the decision making algorithm uses a first threshold value to generate a decision, and wherein modifying the decision making algorithm comprises replacing the first threshold value with a second threshold value.

16. The system of claim 9, wherein the simulation is performed on a Structured Query Language-based platform, and the second programming language is a Structured Query Language.

17. The system of claim 9, wherein the online decision engine comprises a business rule management system.

18. A non-transitory machine readable medium having stored thereon machine-readable instructions executable to cause a machine to perform operations comprising:
obtaining first programming codes that implement a decision making algorithm in a first programming language corresponding to an online decision engine;
generating second programming codes that implement the decision-making algorithm in a second programming language based on the first programming codes, wherein the second programming language provides an interface for direct access of a database system;
performing a simulation of the decision making algorithm by executing the second programming codes to directly access the database system to generate simulation results; and
in response to performing the simulation, modifying the online decision engine based on the simulation results.

19. The non-transitory machine readable medium of claim 18, wherein the decision making algorithm is an inactive algorithm in the online decision engine, wherein modifying the online decision engine comprises:
activating the decision making algorithm in the online decision engine based on the simulation results.

20. The non-transitory machine readable medium of claim 18, wherein the decision making algorithm uses a threshold value to produce an outcome, wherein modifying the online decision engine comprises:
adjusting the threshold value associated with the decision-making algorithm in the online decision engine based on the simulation results.
